(19) United States
(12) Patent Application Publication
(10) Pub. No.: US 2024/0174811 A1
(43) Pub. Date: May 30, 2024

(54) MODIFIED BISMALEIMIDE RESIN

(71) Applicant: NAN YA PLASTICS CORPORATION, TAIPEI (TW)

(72) Inventors: Te-Chao Liao, TAIPEI (TW); Chi-Lin Chen, TAIPEI (TW)

(73) Assignee: NAN YA PLASTICS CORPORATION, TAIPEI (TW)

(21) Appl. No.: 18/088,782

(22) Filed: Dec. 27, 2022

(30) Foreign Application Priority Data
Nov. 3, 2022 (TW) 111142080

(51) Int. Cl. C08G 73/10

(52) U.S. Cl. CPC C08G 73/1071

(57) ABSTRACT

A modified bismaleimide resin is provided. The modified bismaleimide resin is formed from a fluorine-based diamine and a maleic anhydride by a condensation polymerization. The fluorine-based diamine includes a fluorine group, a fluorine-containing substituent or a combination thereof, and further includes an arylene group, an ether group, an alkylene group, an amide group or a combination thereof.

### CROSS-REFERENCE TO RELATED APPLICATION

This application claims the priority benefit of Taiwan application serial no. 111142080, filed on Nov. 3, 2022. The entirety of the above-mentioned patent application is hereby incorporated by reference herein and made a part of this specification.

### BACKGROUND

### Technical Field

The invention relates to a bismaleimide resin, particularly to a modified bismaleimide resin.

### Description of Related Art

Bismaleimide resins have good heat resistance, mechanical properties, dielectric constant (Dk) and dissipation factor (Df) and other characteristics, so it is usually applied in insulating materials of high-frequency printed circuit boards and other electronic substrates. However, the currently used bismaleimide resin has problems such as poor solubility and low toughness, which in turn has the disadvantage of poor processability.

### SUMMARY

The invention provides a modified bismaleimide resin capable of providing good heat resistance, dielectric properties and solubility.

A modified bismaleimide resin of the invention is formed from a fluorine-based diamine and a maleic anhydride by a condensation polymerization. The fluorine-based diamine includes a fluorine group, a fluorine-containing substituent or a combination thereof, and further includes an arylene group, an ether group, an alkylene group, an amide group or a combination thereof.

In an embodiment of the invention, a ratio of a mole number of the fluorine-based diamine to a mole number of the maleic anhydride is 1:1 to 1:10.

In an embodiment of the invention, a weight average molecular weight of the modified bismaleimide resin is 100 to 1,500.

In an embodiment of the invention, the fluorine-based diamine has a symmetric structure.

In an embodiment of the invention, the fluorine-based diamine includes any one of compounds represented by Formula (1) to Formula (16) as follows:

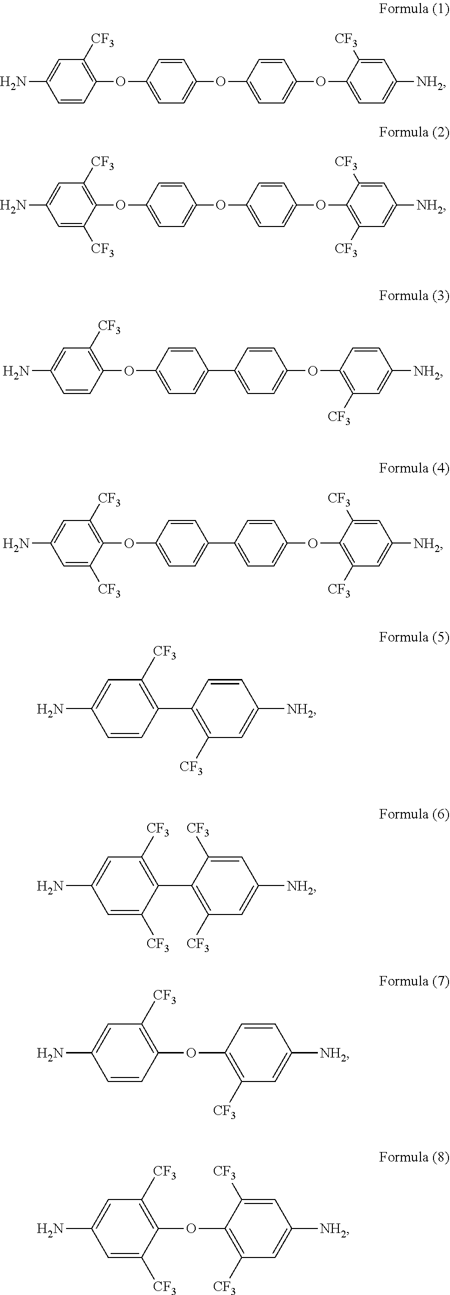

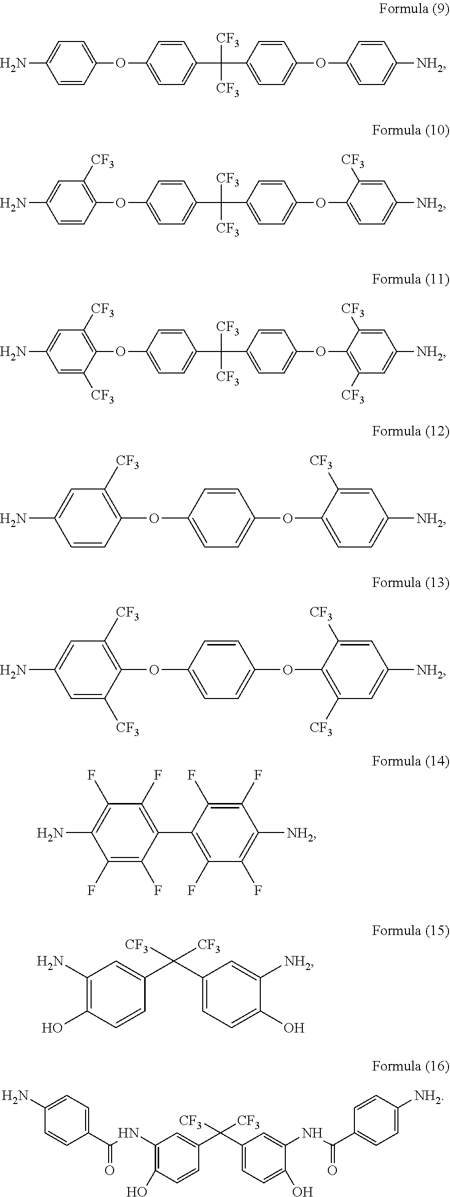

A modified bismaleimide resin of the invention has a structure represented by Formula (A) as follows:

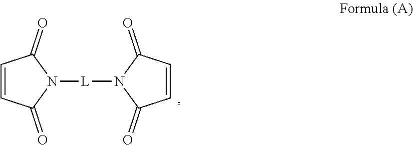

in Formula (A), L represents a divalent organic group derived from a fluorine-based diamine, wherein the fluorine-based diamine includes a fluorine group, a fluorine-containing substituent or a combination thereof, and further includes an arylene group, an ether group, an alkylene group, an amide group or a combination thereof.

In an embodiment of the invention, the L represents any one of divalent organic groups represented by Formula (1a) to Formula (16a) as follows:

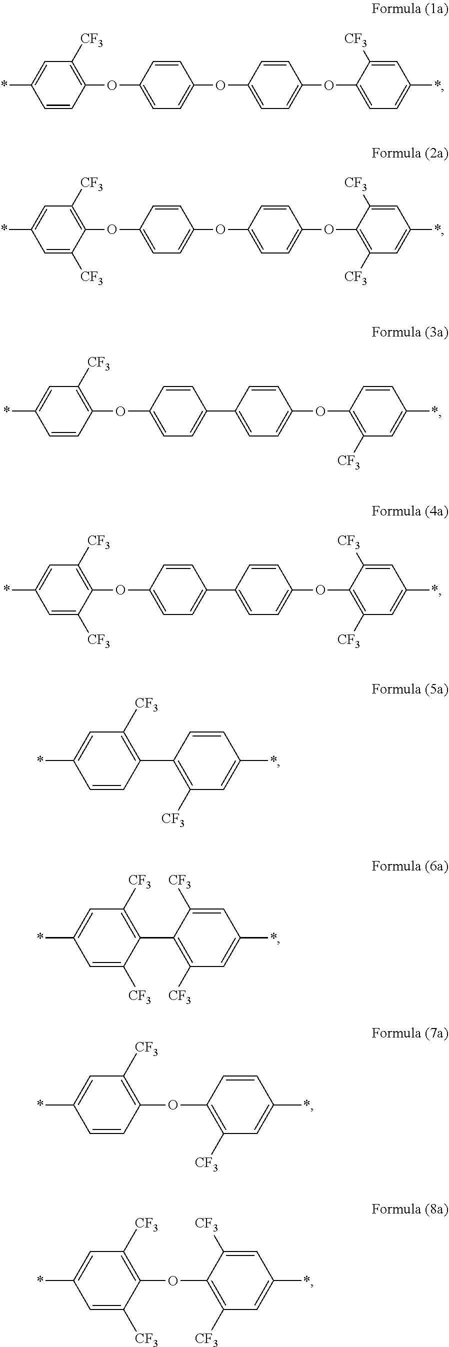

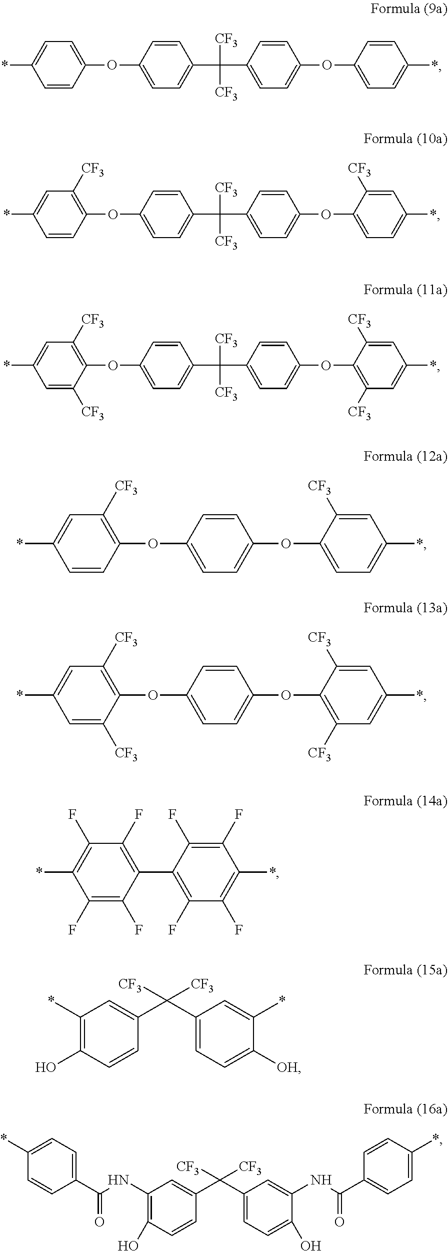

in Formula (1a) to Formula (16a), * represents a bonding position.

Based on the above, the invention provides a bismaleimide resin for which the main chain includes fluorine, which has good heat resistance, dielectric properties and solubility.

To make the features and advantages of the disclosure to be comprehended more easily, embodiments are described in detail as follows.

### DESCRIPTION OF THE EMBODIMENTS

The following are embodiments describing the content of the invention in detail. The implementation details provided in the embodiments are for illustrative purposes, and are not intended to limit the scope of protection of the content of the invention. Those with ordinary knowledge in the art may modify or change these implementation details according to the needs of the actual implementation.

The “divalent organic group” as used in the specification is an organic group having two bonding positions. And the “divalent organic group” may form two chemical bonds through these two bonding positions.

A modified bismaleimide resin of the embodiment is formed from a fluorine-based diamine and a maleic anhydride by a condensation polymerization, wherein the fluorine-based diamine includes a fluorine group, a fluorine-containing substituent or a combination thereof, and further includes an arylene group, an ether group, an alkylene group, an amide group or a combination thereof.

Thus, the modified bismaleimide resin of the embodiment has a structure in which the main chain includes fluorine, which makes the modified bismaleimide resin have good heat resistance, dielectric properties and solubility.

The fluorine-based diamine includes a fluorine group, a fluorine-containing substituent or a combination thereof. And the fluorine-based diamine further includes an arylene group, an ether group, an alkylene group, an amide group or a combination thereof, preferably an arylene group, an ether group or a combination thereof. In this embodiment, the fluorine-based diamine may have a symmetric structure. The fluorine-based diamine may include any one of compounds represented by Formula (1) to Formula (16) as follows, preferably a compound represented by Formula (3), Formula (4), Formula (6), Formula (12) or Formula (13).

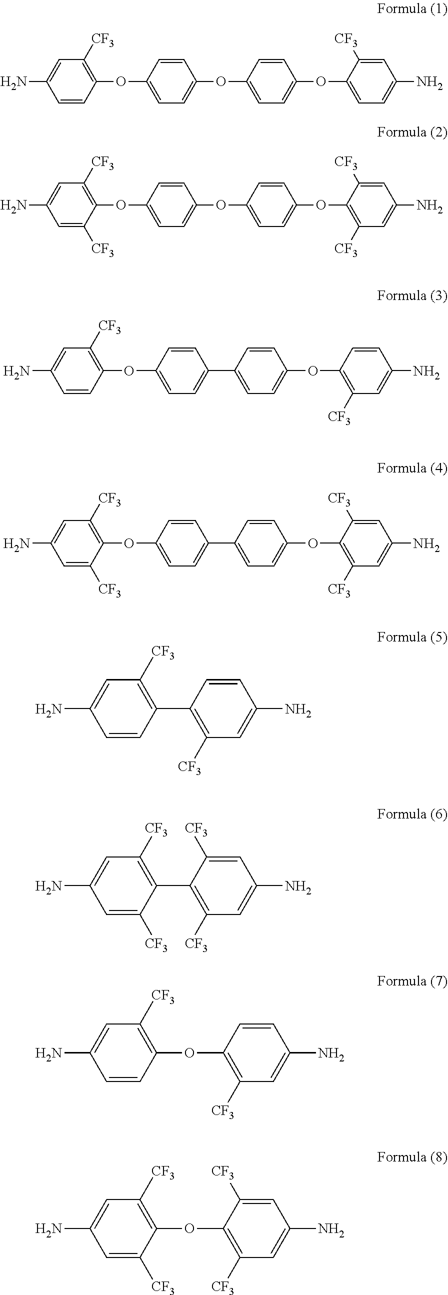

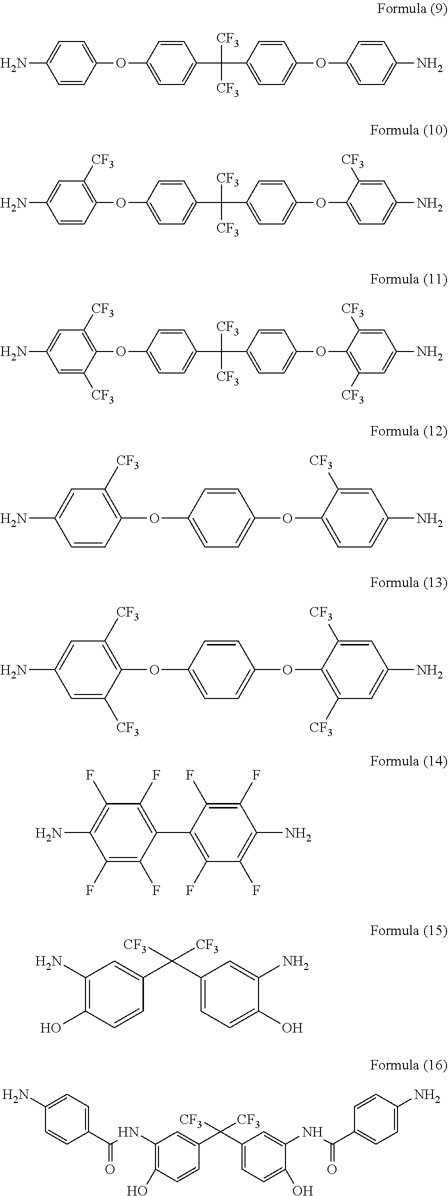

A modified bismaleimide resin with symmetric structure (that is, dipole moment approaches 0) may be obtained by reacting a fluorine-based diamine having symmetrical structure with maleic anhydride. Thereby, the modified bismaleimide resin may have good heat resistance, dielectric properties and solubility.

### Preparation Method of Modified Bismaleimide Resin

A modified bismaleimide resin is formed from a fluorine-based diamine and a maleic anhydride by a condensation polymerization. The method of reacting the fluorine-based diamine and the maleic anhydride is not particularly limited, for example, it may be synthesized by well-known organic synthesis methods, which will not be described in detail here. In this embodiment, a ratio of a mole number of the fluorine-based diamine to a mole number of the maleic anhydride is 1:1 to 1:10, preferably 1:2 to 1:3.

The modified bismaleimide resin has a structure represented by Formula (A) as follows. In this embodiment, a weight average molecular weight of the modified bismaleimide resin is 100 to 1,500, preferably 400 to 800.

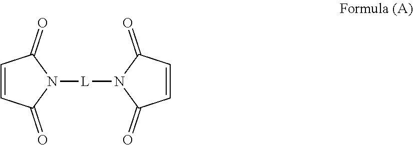

In Formula (A), L represents a divalent organic group derived from a fluorine-based diamine, wherein the fluorine-based diamine includes a fluorine group, a fluorine-containing substituent or a combination thereof; and the fluorine-based diamine further includes an arylene group, an ether group, an alkylene group, an amide group or a combination thereof; preferably an arylene group, an ether group or a combination thereof.

In this embodiment, L may represent any one of divalent organic groups represented by Formula (1a) to Formula (16a) as follows, preferably a divalent organic group represented by Formula (3a), Formula (4a), Formula (6a), Formula (12a) or Formula (13a).

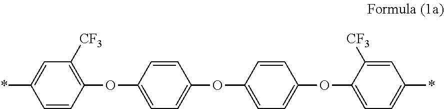 [SMILES: *c1ccc(Oc2ccc(Oc3ccc(Oc4ccc(*)cc4C(F)(F)F)cc3)cc2)c(C(F)(F)F)c1]

In Formula (1a), * represents a bonding position. The divalent organic group represented by Formula (1a) may be derived from the compound represented by Formula (1) above.

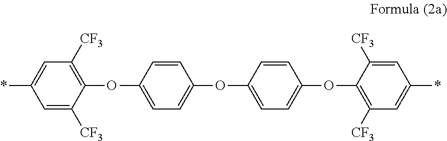 [SMILES: *c1cc(C(F)(F)F)c(Oc2ccc(Oc3ccc(Oc4c(C(F)(F)F)cc(*)cc4C(F)(F)F)cc3)cc2)c(C(F)(F)F)c1]

In Formula (2a), * represents a bonding position. The divalent organic group represented by Formula (2a) may be derived from the compound represented by Formula (2) above.

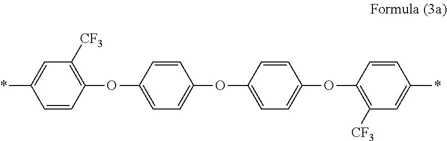 [SMILES: *c1ccc(Oc2ccc(Oc3ccc(Oc4ccc(*)cc4C(F)(F)F)cc3)cc2)c(C(F)(F)F)c1]

In Formula (3a), * represents a bonding position. The divalent organic group represented by Formula (3a) may be derived from the compound represented by Formula (3) above.

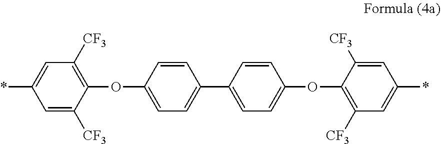 [SMILES: *c1cc(C(F)(F)F)c(Oc2ccc(-c3ccc(Oc4c(C(F)(F)F)cc(*)cc4C(F)(F)F)cc3)cc2)c(C(F)(F)F)c1]

In Formula (4a), * represents a bonding position. The divalent organic group represented by Formula (4a) may be derived from the compound represented by Formula (4) above.

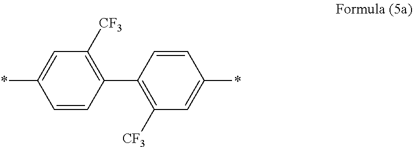 [SMILES: *c1ccc(-c2ccc(*)cc2C(F)(F)F)c(C(F)(F)F)c1]

In Formula (5a), * represents a bonding position. The divalent organic group represented by Formula (5a) may be derived from the compound represented by Formula (5) above.

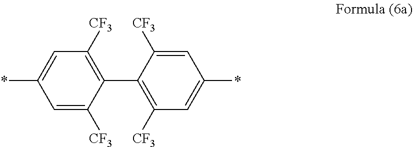 [SMILES: *c1cc(C(F)(F)F)c(-c2c(C(F)(F)F)cc(*)cc2C(F)(F)F)c(C(F)(F)F)c1]

In Formula (6a), * represents a bonding position. The divalent organic group represented by Formula (6a) may be derived from the compound represented by Formula (6) above.

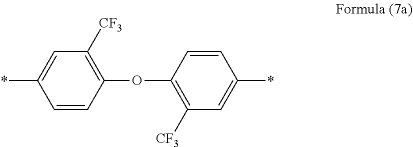 [SMILES: *c1ccc(Oc2ccc(*)cc2C(F)(F)F)c(C(F)(F)F)c1]

In Formula (7a), * represents a bonding position. The divalent organic group represented by Formula (7a) may be derived from the compound represented by Formula (7) above.

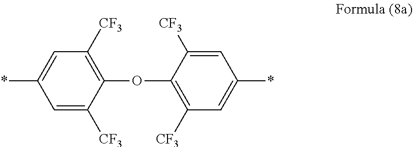 [SMILES: *c1cc(C(F)(F)F)c(Oc2c(C(F)(F)F)cc(*)cc2C(F)(F)F)c(C(F)(F)F)c1]

In Formula (8a), * represents a bonding position. The divalent organic group represented by Formula (8a) may be derived from the compound represented by Formula (8) above.

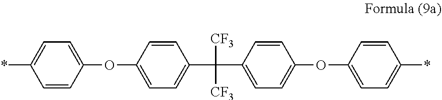 [SMILES: *c1ccc(Oc2ccc(C(c3ccc(Oc4ccc(*)cc4)cc3)(C(F)(F)F)C(F)(F)F)cc2)cc1]

In Formula (9a), * represents a bonding position. The divalent organic group represented by Formula (9a) may be derived from the compound represented by Formula (9) above.

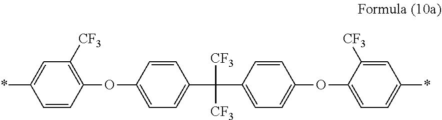 [SMILES: *c1ccc(Oc2ccc(C(c3ccc(Oc4ccc(*)cc4C(F)(F)F)cc3)(C(F)(F)F)C(F)(F)F)cc2)c(C(F)(F)F)c1]

In Formula (10a), * represents a bonding position. The divalent organic group represented by Formula (10a) may be derived from the compound represented by Formula (10) above.

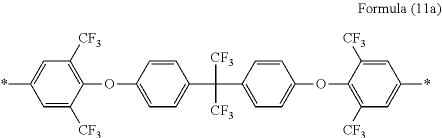 [SMILES: *c1cc(C(F)(F)F)c(Oc2ccc(C(c3ccc(Oc4c(C(F)(F)F)cc(*)cc4C(F)(F)F)cc3)(C(F)(F)F)C(F)(F)F)cc2)c(C(F)(F)F)c1]

In Formula (11a), * represents a bonding position. The divalent organic group represented by Formula (11a) may be derived from the compound represented by Formula (11) above.

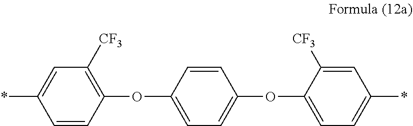 [SMILES: *c1ccc(Oc2ccc(Oc3ccc(*)cc3C(F)(F)F)cc2)c(C(F)(F)F)c1]

In Formula (12a), * represents a bonding position. The divalent organic group represented by Formula (12a) may be derived from the compound represented by Formula (12) above.

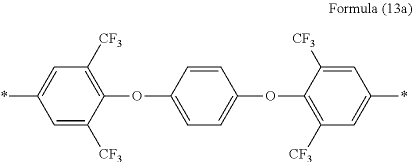 [SMILES: *c1cc(C(F)(F)F)c(Oc2ccc(Oc3c(C(F)(F)F)cc(*)cc3C(F)(F)F)cc2)c(C(F)(F)F)c1]

In Formula (13a), * represents a bonding position. The divalent organic group represented by Formula (13a) may be derived from the compound represented by Formula (13) above.

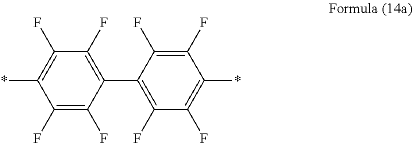 [SMILES: *c1c(F)c(F)c(-c2c(F)c(F)c(*)c(F)c2F)c(F)c1F]

In Formula (14a), * represents a bonding position. The divalent organic group represented by Formula (14a) may be derived from the compound represented by Formula (14) above.

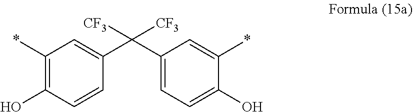 [SMILES: *c1cc(C(c2ccc(O)c(*)c2)(C(F)(F)F)C(F)(F)F)ccc1O]

In Formula (15a), * represents a bonding position. The divalent organic group represented by Formula (15a) may be derived from the compound represented by Formula (15) above.

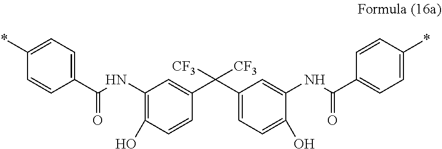 [SMILES: *c1ccc(C(=O)Nc2cc(C(c3ccc(O)c(NC(=O)c4ccc(*)cc4)c3)(C(F)(F)F)C(F)(F)F)ccc2O)cc1]

In Formula (16a), * represents a bonding position. The divalent organic group represented by Formula (16a) may be derived from the compound represented by Formula (16) above.

### Examples of Modified Bismaleimide Resin

Example 1 to Example 16 and Comparative Example 1 of the modified bismaleimide resin are described below:

### Example 1

104 g (0.2 mol) of fluorine-based diamine compound represented by Formula (1) and 43.1 g (0.44 mol) of maleic anhydride were added to 300 mL of acetone to form a solution to be reacted. Next, the solution to be reacted was poured into a four-neck round bottom reaction flask, nitrogen was blown to remove air and moisture, and stirred at 100° C. and normal pressure for 1 to 3 hours to make the fluorine-based diamine and maleic anhydride react. When the reaction temperature reached 80° C., it was observed that the solution in the reaction flask had turned into a reddish-brown clear solution. At this moment, 4 g of sodium acetate, 140 mL of acetic acid and 28 mL of triethylamine were sequentially added/dropped thereto, and reacted at a temperature of 100° C. for 14 hours to let the reddish-brown clear solution turn into a dark reddish-brown and viscous solution. Next, precipitation and purification process were performed to precipitate light brown resin particles from the dark reddish-brown and viscous solution, and after removing impurities such as unreacted monomers and residual acids, the modified bismaleimide resin of Example 1 was obtained (80 g of reddish-brown modified bismaleimide resin particles).

### Example 2

The modified bismaleimide resin of Example 2 was prepared using the same steps as Example 1, and using the synthesis conditions listed in Table 1. The difference between Example 2 and Example 1 is: the fluorine-based diamine compound represented by Formula (1) was replaced by the fluorine-based diamine compound represented by Formula (2). The obtained modified bismaleimide resin was evaluated by each of the following evaluation methods, and the results thereof are as shown in Table 2.

### Example 3

The modified bismaleimide resin of Example 3 was prepared using the same steps as Example 1, and using the synthesis conditions listed in Table 1. The difference between Example 3 and Example 1 is: the fluorine-based diamine compound represented by Formula (1) was replaced by the fluorine-based diamine compound represented by Formula (3). The obtained modified bismaleimide resin was evaluated by each of the following evaluation methods, and the results thereof are as shown in Table 2.

### Example 4

The modified bismaleimide resin of Example 4 was prepared using the same steps as Example 1, and using the synthesis conditions listed in Table 1. The difference between Example 4 and Example 1 is: the fluorine-based diamine compound represented by Formula (1) was replaced by the fluorine-based diamine compound represented by Formula (4). The obtained modified bismaleimide resin was evaluated by each of the following evaluation methods, and the results thereof are as shown in Table 2.

### Example 5

The modified bismaleimide resin of Example 5 was prepared using the same steps as Example 1, and using the synthesis conditions listed in Table 1. The difference between Example 5 and Example 1 is: the fluorine-based diamine compound represented by Formula (1) was replaced by the fluorine-based diamine compound represented by Formula (5). The obtained modified bismaleimide resin was evaluated by each of the following evaluation methods, and the results thereof are as shown in Table 2.

### Example 6

The modified bismaleimide resin of Example 6 was prepared using the same steps as Example 1, and using the synthesis conditions listed in Table 1. The difference between Example 6 and Example 1 is: the fluorine-based diamine compound represented by Formula (1) was replaced by the fluorine-based diamine compound represented by Formula (6). The obtained modified bismaleimide resin was evaluated by each of the following evaluation methods, and the results thereof are as shown in Table 2.

### Example 7

The modified bismaleimide resin of Example 7 was prepared using the same steps as Example 1, and using the synthesis conditions listed in Table 1. The difference between Example 7 and Example 1 is: the fluorine-based diamine compound represented by Formula (1) was replaced by the fluorine-based diamine compound represented by Formula (7). The obtained modified bismaleimide resin was evaluated by each of the following evaluation methods, and the results thereof are as shown in Table 2.

### Example 8

The modified bismaleimide resin of Example 8 was prepared using the same steps as Example 1, and using the synthesis conditions listed in Table 1. The difference between Example 8 and Example 1 is: the fluorine-based diamine compound represented by Formula (1) was replaced by the fluorine-based diamine compound represented by Formula (8). The obtained modified bismaleimide resin was evaluated by each of the following evaluation methods, and the results thereof are as shown in Table 2.

### Example 9

The modified bismaleimide resin of Example 9 was prepared using the same steps as Example 1, and using the synthesis conditions listed in Table 1. The difference between Example 9 and Example 1 is: the fluorine-based diamine compound represented by Formula (1) was replaced by the fluorine-based diamine compound represented by Formula (9). The obtained modified bismaleimide resin was evaluated by each of the following evaluation methods, and the results thereof are as shown in Table 2.

### Example 10

The modified bismaleimide resin of Example 10 was prepared using the same steps as Example 1, and using the synthesis conditions listed in Table 1. The difference between Example 10 and Example 1 is: the fluorine-based diamine compound represented by Formula (1) was replaced by the fluorine-based diamine compound represented by Formula (10). The obtained modified bismaleimide resin was evaluated by each of the following evaluation methods, and the results thereof are as shown in Table 2.

### Example 11

The modified bismaleimide resin of Example 11 was prepared using the same steps as Example 1, and using the synthesis conditions listed in Table 1. The difference between Example 11 and Example 1 is: the fluorine-based diamine compound represented by Formula (1) was replaced by the fluorine-based diamine compound represented by Formula (11). The obtained modified bismaleimide resin was evaluated by each of the following evaluation methods, and the results thereof are as shown in Table 2.

### Example 12

The modified bismaleimide resin of Example 12 was prepared using the same steps as Example 1, and using the synthesis conditions listed in Table 1. The difference between Example 12 and Example 1 is: the fluorine-based diamine compound represented by Formula (1) was replaced by the fluorine-based diamine compound represented by Formula (12). The obtained modified bismaleimide resin was evaluated by each of the following evaluation methods, and the results thereof are as shown in Table 2.

### Example 13

The modified bismaleimide resin of Example 13 was prepared using the same steps as Example 1, and using the synthesis conditions listed in Table 1. The difference between Example 13 and Example 1 is: the fluorine-based diamine compound represented by Formula (1) was replaced by the fluorine-based diamine compound represented by Formula (13). The obtained modified bismaleimide resin was evaluated by each of the following evaluation methods, and the results thereof are as shown in Table 2.

### Example 14

The modified bismaleimide resin of Example 14 was prepared using the same steps as Example 1, and using the synthesis conditions listed in Table 1. The difference between Example 14 and Example 1 is: the fluorine-based diamine compound represented by Formula (1) was replaced by the fluorine-based diamine compound represented by Formula (14). The obtained modified bismaleimide resin was evaluated by each of the following evaluation methods, and the results thereof are as shown in Table 2.

### Example 15

The modified bismaleimide resin of Example 15 was prepared using the same steps as Example 1, and using the synthesis conditions listed in Table 1. The difference between Example 15 and Example 1 is: the fluorine-based diamine compound represented by Formula (1) was replaced by the fluorine-based diamine compound represented by Formula (15). The obtained modified bismaleimide resin was evaluated by each of the following evaluation methods, and the results thereof are as shown in Table 2.

### Example 16

The modified bismaleimide resin of Example 16 was prepared using the same steps as Example 1, and using the synthesis conditions listed in Table 1. The difference between Example 16 and Example 1 is: the fluorine-based diamine compound represented by Formula (1) was replaced by the fluorine-based diamine compound represented by Formula (16). The obtained modified bismaleimide resin was evaluated by each of the following evaluation methods, and the results thereof are as shown in Table 2.

### Comparative Example 1

The bismaleimide resin of Comparative example 1 is a commercially available bismaleimide resin KI-70 (trade name, having a structure of Formula (B) as follows; manufactured by KI Chemical Industry Co., LTD.). It was evaluated by each of the following evaluation methods, and the results thereof are as shown in Table 2.

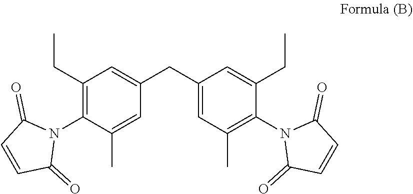 [SMILES: CCc1cc(Cc2cc(C)c(N3C(=O)C=CC3=O)c(CC)c2)cc(C)c1N1C(=O)C=CC1=O]

TABLE 1

| | | Examples | | | | | |
|---|---|---|---|---|---|---|---|
| Items | | 1 | 2 | 3 | 4 | 5 | 6 |
| Fluorine-based | | 104 | 131 | 128 | 100 | 64 | 91 |
| diamine compound (g) | | | | | | | |
| Maleic anhydride (g) | | 43.1 | 43.1 | 43.1 | 43.1 | 43.1 | 43.1 |
| Solvent | Acetone (mL) | 300 | — | — | — | — | — |
| | DMF (mL) | — | 245 | 266 | — | — | 300 |
| | Toluene (mL) | — | — | — | 270 | 430 | — |
| Additive | Sodium acetate (g) | 4.0 | 4.5 | 3.4 | 4.7 | 3.0 | 4.0 |
| | Acetic acid (mL) | 140 | 152 | 130 | 132 | 156 | 164 |
| | Triethylamine (mL) | 28 | 30 | 35 | 40 | 44 | 33 |
| Reaction | Temperature (° C.) | 100 | 95 | 110 | 140 | 90 | 100 |
| conditions | Pressure | N.P. | N.P. | N.P. | N.P. | N.P. | N.P. |
| | Time (hour) | 14 | 18 | 14 | 19 | 22 | 12 |
| | | Examples | | | | | |
| Items | | 7 | 8 | 9 | 10 | 11 | 12 |
| Fluorine-based | | 67 | 95 | 104 | 131 | 158 | 86 |
| diamine compound (g) | | | | | | | |
| Maleic anhydride (g) | | 43.1 | 43.1 | 43.1 | 43.1 | 43.1 | 43.1 |
| Solvent | Acetone (mL) | — | — | 325 | 330 | 300 | — |
| | DMF (mL) | 420 | 410 | — | — | — | 400 |
| | Toluene (mL) | — | — | — | — | — | — |
| Additive | Sodium acetate (g) | 4.2 | 3.0 | 3.0 | 3.5 | 3.2 | 4.0 |
| | Acetic acid (mL) | 172 | 140 | 145 | 150 | 140 | 144 |
| | Triethylamine (mL) | 32 | 30 | 31 | 33 | 34 | 39 |
| Reaction | Temperature (° C.) | 120 | 115 | 105 | 100 | 120 | 90 |
| conditions | Pressure | N.P. | N.P. | N.P. | N.P. | N.P. | N.P. |
| | Time (hour) | 16 | 18 | 14 | 14 | 16 | 17 |

| | | Examples | | | |
|---|---|---|---|---|---|
| Items | | 13 | 14 | 15 | 16 |
| Fluorine-based | | 113 | 66 | 73 | 121 |
| diamine compound (g) | | | | | |
| Maleic anhydride (g) | | 43.1 | 43.1 | 43.1 | 43.1 |
| Solvent | Acetone (mL) | — | — | — | — |
| | DMF (mL) | 410 | — | — | — |
| | Toluene (mL) | — | 370 | 360 | 350 |
| Additive | Sodium acetate (g) | 3.7 | 4.2 | 4.1 | 3.4 |
| | Acetic acid (mL) | 155 | 157 | 160 | 162 |
| | Triethylamine (mL) | 40 | 33 | 30 | 32 |
| Reaction | Temperature (° C.) | 95 | 100 | 125 | 120 |
| conditions | Pressure | N.P. | N.P. | N.P. | N.P. |
| | Time (hour) | 19 | 14 | 17 | 16 |

* DMF represents dimethylformamide.
*N.P. represents normal pressure.

TABLE 2

| | Examples | | | | | |
|---|---|---|---|---|---|---|
| Items | 1 | 2 | 3 | 4 | 5 | 6 |
| Tg (unit: ° C.) | 217 | 220 | 231 | 246 | 242 | 240 |
| Dielectric | 2.40 | 2.32 | 2.57 | 2.48 | 2.71 | 2.41 |
| constant (Dk) | | | | | | |
| Dissipation | 0.0049 | 0.0030 | 0.0040 | 0.0028 | 0.0023 | 0.0020 |
| factor (Df) | | | | | | |
| Solubility | 40 | 40 | 30 | 45 | 30 | 40 |
| Color | Reddish- | Dark | Reddish- | Reddish- | Reddish- | Dark |
| | brown | brown | brown | brown | brown | brown |
| | Examples | | | | | |
| Items | 7 | 8 | 9 | 10 | 11 | 12 |
| Tg (unit: ° C.) | 230 | 231 | 232 | 216 | 220 | 237 |
| Dielectric | 2.76 | 2.66 | 2.65 | 2.55 | 2.43 | 2.62 |
| constant (Dk) | | | | | | |
| Dissipation | 0.0060 | 0.0044 | 0.0045 | 0.0042 | 0.0038 | 0.0027 |
| factor (Df) | | | | | | |
| Solubility | 35 | 30 | 40 | 35 | 30 | 35 |
| Color | Reddish- | Dark | Reddish- | Dark | Dark | Dark |
| | brown | brown | brown | brown | brown | brown |

| | Examples | | | | Comparative |
|---|---|---|---|---|---|
| Items | 13 | 14 | 15 | 16 | example 1 |
| Tg (unit: ° C.) | 240 | 298 | 220 | 230 | 225 |
| Dielectric | 2.60 | 2.74 | 2.80 | 2.90 | 2.65 |
| constant (Dk) | | | | | |
| Dissipation | 0.0022 | 0.0025 | 0.0042 | 0.0047 | 0.0041 |
| factor (Df) | | | | | |
| Solubility | 35 | 20 | 30 | 35 | 20 |
| Color | Dark | Dark | Dark | Dark | Pale |
| | brown | brown | brown | brown | yellow |

### Evaluation Methods

The modified bismaleimide resin/commercially available bismaleimide resin of Examples/Comparative Examples was made into a resin composition in the form of a resin varnish. The resin composition may include a functional additive to improve various properties required for practical use. For example, the functional additive may be selected from at least one of a flame retardant, a solvent a filler and a hardening accelerator.

Next, the resin composition was applied to a substrate at an appropriate temperature (for example, room temperature). The substrate is not particularly limited, and suitable substrate may be selected according to needs. The substrate may include an insulating paper, a fiberglass cloth or other suitable fiber materials. The method of applying the resin composition to the substrate may include coating or impregnation.

Then, the substrate applied with the resin composition was dried at an appropriate temperature for a period of time to form a prepreg in a semi-cured state. Finally, copper foil layers were laminated on one or both sides of at least one prepreg, and performed thermocompression bonding to form a copper foil substrate. The condition of the thermocompression bonding is not particularly limited, and the condition of the thermocompression bonding may be adjusted according to a composition of the resin composition. The prepared copper foil substrate was evaluated by each of the following evaluation methods, and the results thereof are as shown in Table 2.

### a. Glass Transition Temperature (Tg)

The prepared modified bismaleimide resin was measured for a glass transition temperature (Tg) via a dynamic mechanical analyzer (DMA). When the Tg is greater, the modified bismaleimide resin has good resistance to phase changes, that is, good heat resistance.

Heating rate: 10° C./min

Temperature range: 25° C. to 350° C. (heating, cooling, heating)

### b. Dielectric Constant (Dk)

The prepared copper foil substrate was measured for a dielectric constant (Dk) at a frequency of 10 GHz via a dielectric analyzer (model: E4991A; manufactured by Agilent Technologies, Inc.). When the dielectric constant is smaller, the modified bismaleimide resin has good dielectric property.

### c. Dissipation Factor (DI)

The copper foil substrate was measured for a dissipation factor (DO at a frequency of 10 GHz via a dielectric analyzer (model: E4991A; manufactured by Agilent Technologies, Inc.). When the dissipation factor is smaller, the modified bismaleimide resin has good dielectric property.

### d. Solubility

The prepared modified bismaleimide resin/commercially available bismaleimide resin was added to a solvent, wherein the solvent is 100 g of dimethylformamide (DMF) or tetrahydrofuran (THF). When the solvent cannot dissolve the bismaleimide resin, a weight of the dissolved bismaleimide resin is the solubility. When the solvent dissolves more resin, the modified bismaleimide resin has good solubility.

### e. Color

The color of the prepared modified bismaleimide resin/commercially available bismaleimide resin was directly observed with the naked eye.

### Evaluation Results

It may be seen from Table 2 that when the modified bismaleimide resin has a structure for which the main chain includes fluorine (Examples 1˜16), the modified bismaleimide resin has good heat resistance, dielectric properties and solubility at the same time.

In addition, compared to the modified bismaleimide resin for which the main chain does not include fluorine (Comparative example 1), the modified bismaleimide resins for which the main chain includes fluorine (Examples 1˜16) have better heat resistance, dielectric properties and/or solubility.

In addition, compared to the modified bismaleimide resin formed by reacting a fluorine-based diamine compound represented by Formula (1), Formula (2), Formula (5), Formula (7) to Formula (11) or Formula (14) to Formula (16) and a maleic anhydride (Examples 1, 2, 5, 7˜11, 14˜16), the modified bismaleimide resin formed by reacting a fluorine-based diamine compound represented by Formula (3), Formula (4), Formula (6), Formula (12) or Formula (13) and a maleic anhydride (Examples 3, 4, 6, 12, 13) have better heat resistance, dielectric properties and solubility at the same time.

Based on the above, the modified bismaleimide resin of the invention has a structure for which the main chain includes fluorine, so it has good heat resistance, dielectric properties and solubility. Therefore, the modified bismaleimide resin has good applicability, for example, for printed circuit boards.

Although the invention has been disclosed in the embodiments above, they are not intended to limit the invention. Anyone with ordinary knowledge in the relevant technical field can make changes and modifications without departing from the spirit and scope of the invention. The scope of protection of the invention shall be subject to those defined by the claims attached.

What is claimed is:

1. A modified bismaleimide resin, formed from a fluorine-based diamine and a maleic anhydride by a condensation polymerization,
wherein the fluorine-based diamine comprises a fluorine group, a fluorine-containing substituent or a combination thereof, and further comprises an arylene group, an ether group, an alkylene group, an amide group or a combination thereof.

2. The modified bismaleimide resin according to claim 1, wherein a ratio of a mole number of the fluorine-based diamine to a mole number of the maleic anhydride is 1:1 to 1:10.

3. The modified bismaleimide resin according to claim 1, a weight average molecular weight thereof is 100 to 1,500.

4. The modified bismaleimide resin according to claim 1, wherein the fluorine-based diamine has a symmetric structure.

5. The modified bismaleimide resin according to claim 1, wherein the fluorine-based diamine comprises any one of compounds represented by Formula (1) to Formula (16) as follows:

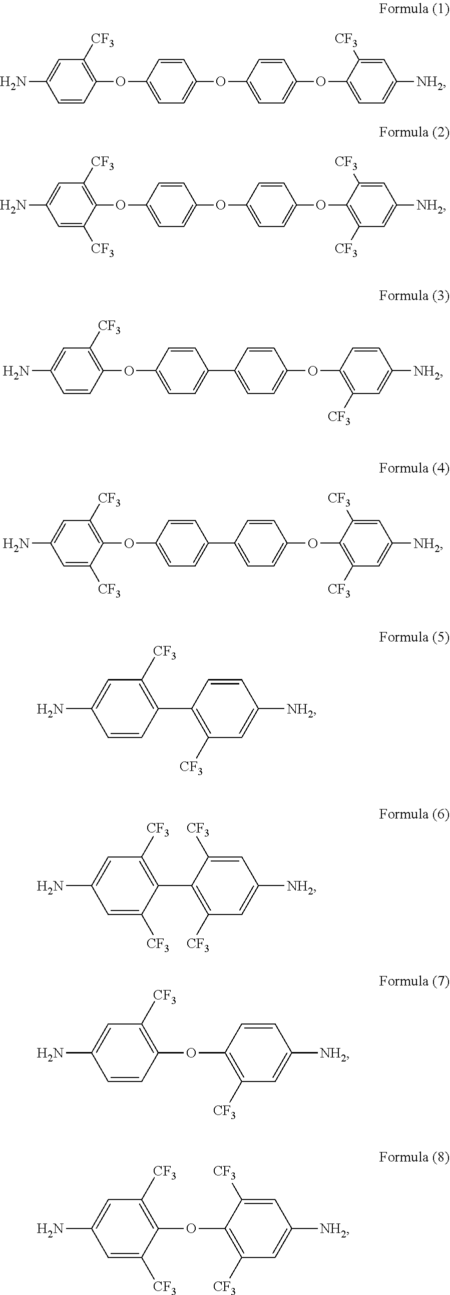

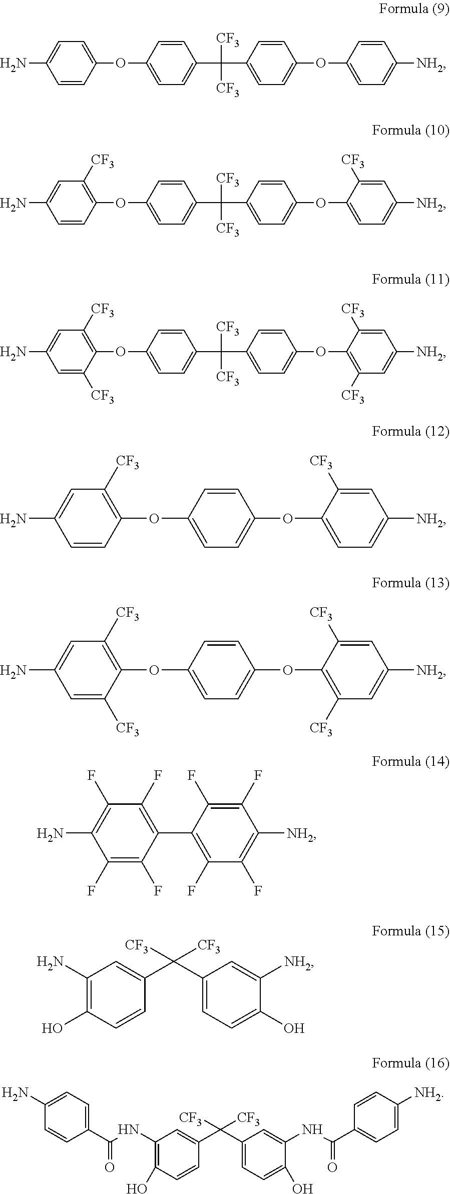

6. A modified bismaleimide resin, having a structure represented by Formula (A) as 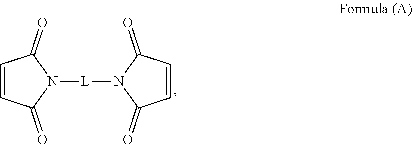
in Formula (A), L represents a divalent organic group derived from a fluorine-based diamine, wherein the fluorine-based diamine comprises a fluorine group, a fluorine-containing substituent or a combination thereof, and further comprises an arylene group, an ether group, an alkylene group, an amide group or a combination thereof.

7. The modified bismaleimide resin according to claim 6, wherein the fluorine-based diamine has a symmetric structure.

8. The modified bismaleimide resin according to claim 6, wherein L represents any one of divalent organic groups represented by Formula (1a) to Formula (16a) as follows: 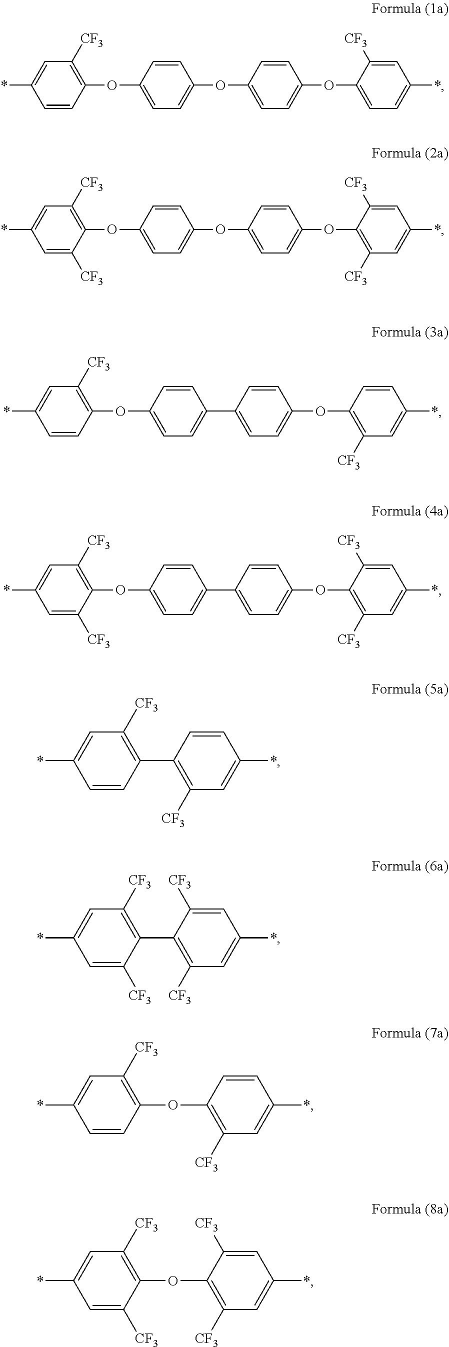 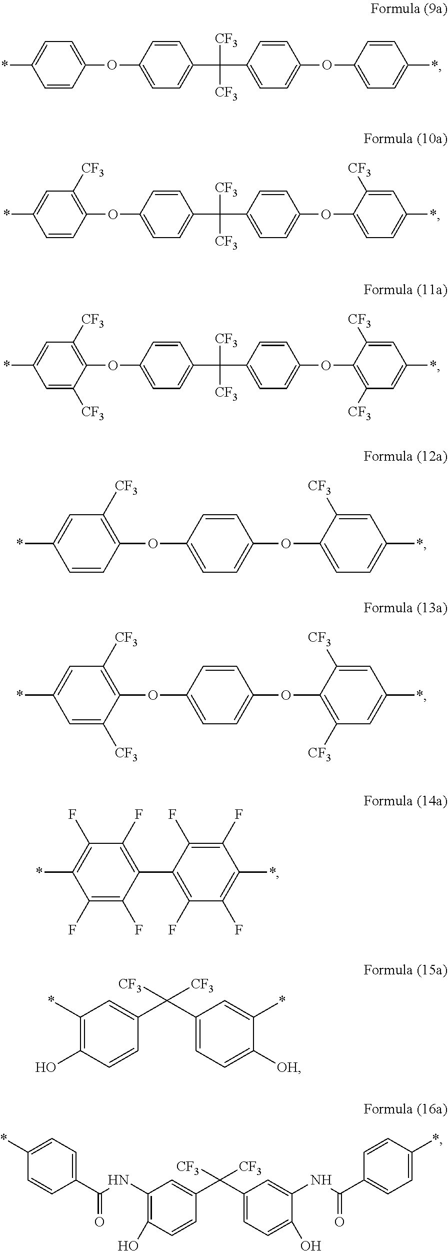
in Formula (1a) to Formula (16a), * represents a bonding position.

9. The modified bismaleimide resin according to claim 6, a weight average molecular weight thereof is 100 to 1,500.
